(19) United States
(12) Patent Application Publication
(10) Pub. No.: US 2025/0247161 A1
(43) Pub. Date: Jul. 31, 2025

(54) SYSTEM AND METHODS FOR MACHINE LEARNING ASSISTED ANALYSIS OF CHANNEL ESTIMATES IN A RADIO ACCESS NETWORK

(71) Applicant: Aira Technologies, Inc., Saratoga, CA (US)

(72) Inventors: Arman Rahimzamani, Saratoga, CA (US); RaviKiran Gopalan, Saratoga, CA (US); Anand Chandrasekher, Saratoga, CA (US)

(21) Appl. No.: 19/039,109

(22) Filed: Jan. 28, 2025

Related U.S. Application Data
(60) Provisional application No. 63/626,431, filed on Jan. 29, 2024.

(51) Int. Cl. H04B 17/309; G06N 3/0455; G06N 3/0464; H04B 17/391; H04L 5/00

(52) U.S. Cl. CPC H04B 17/309; G06N 3/0455; G06N 3/0464; H04B 17/3913; H04L 5/0092; H04L 5/0007

(57) ABSTRACT

A two-stage network model generates desired operational indicators of a network's physical layer based on channel estimates. The operational indicators may include Doppler, delay spread, SNR, time offset, frequency offset, power delay profile, and similar indicators. The first stage includes an information processing flow pipeline. The second stage includes multiple output heads. The information processing flow pipeline processes an input to extract and compress the meaningful information contained therein. This information is then processed by the output heads to produce the desired operational indicators.

### CROSS-REFERENCE TO RELATED APPLICATION

This application claims the benefit of and priority to U.S. Provisional Patent Application No. 63/626,431, entitled “SYSTEM AND METHODS FOR MACHINE LEARNING ASSISTED ANALYSIS OF CHANNEL ESTIMATES IN A RADIO ACCESS NETWORK”, filed on Jan. 29, 2024, which is incorporated herein by reference in its entirety.

### TECHNICAL FIELD

The present disclosure relates generally to wireless communication systems and, more specifically, to systems and methods for generating physical layer insights using deep learning models for frequency and time-domain analysis in Orthogonal Frequency Division Multiplexing (OFDM) communication networks.

### BACKGROUND

Accurate channel estimation is essential for modern radio communication systems, especially in highly dynamic and time-varying environments. Multiple communication functions (beamforming, scheduling, resource allocation, etc.) are highly dependent on accurate channel estimation. In wireless communication systems, the channel between the transmitter and receiver is often characterized by a time-varying, multipath channel. Multipath channel characteristics can vary rapidly due to factors such as mobility and environmental changes.

Accurate channel estimates greatly improve the performance of the wireless network and can benefit all downstream tasks, eventually improving key performance indicators (KPIs) for customers and the network operators. In addition, accurate channel estimates can be used to improve various communications functions such as beamforming, scheduling, and resource allocation. Improving these functions can lead to better quality of service (QOS), higher throughput, and lower packet loss rates. Accurate channel prediction can also improve the QoS and overall performance (e.g., throughput, delay, etc.) of the wireless system by providing information about future channel conditions.

### SUMMARY

In accordance with one or more embodiments, various features and functionalities are provided to employ machine learning in the analysis and synthesis of channel estimates to obtain desired operational indicators of a network's physical layer. For convenience, these indicators are referred to herein as “physical layer insights” or simply “insights.” Example insights may include Doppler, delay spread, SNR, time offset, frequency offset, power delay profile, and similar indicators.

The disclosed embodiments may employ a two-stage network model to generate these insights. The first stage may include an information processing flow pipeline. The second stage may include multiple output heads. The information processing flow pipeline processes an input to extract and compress the meaningful information contained therein. The inputs may include a channel estimate.

The information processing flow pipeline may include a high-dimensional frequency spectrum encoder, a high-dimensional temporal encoder, a low-dimensional frequency spectrum encoder, and a low-dimensional temporal encoder. These encoders extract temporal and spectral data while significantly reducing the dimensionality of the data. The output heads may process this information to produce the desired network insights.

Other features and aspects of the disclosed technology will become apparent from the following detailed description, taken in conjunction with the accompanying drawings, which illustrate by way of example, the features in accordance with embodiments of the disclosed technology. The summary is not intended to limit the scope of any inventions described herein, which are solely defined by the claims attached hereto.

### BRIEF DESCRIPTION OF THE DRAWINGS

The technology disclosed herein, in accordance with one or more various embodiments, is described in detail with reference to the following figures (hereafter referred to as “FIG.”). The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a network model according to some embodiments of the disclosed technology.

FIG. 2 illustrates an information processing flow pipeline according to some embodiments of the disclosed technology.

FIG. 3 is a bar plot of the timing offset estimation accuracy results at various locations within a cell.

FIG. 4 is a bar plot of the frequency offset estimation accuracy results at various locations within a cell.

FIGS. 5A-5D are scatter plots of the performance of the system with respect to SNR estimation at various locations within a cell.

FIGS. 6A-6D are scatter plots of the performance of the system with respect to Doppler estimation at various locations within a cell.

FIGS. 7A-7D are scatter plots of the performance of the system with respect to delay spread estimation at various locations within a cell.

FIG. 8 illustrates an example computing system that may be used in implementing various features of embodiments of the disclosed technology.

### DETAILED DESCRIPTION

With conventional technologies, physical layer insights are difficult to obtain. First, the information for physical layer insights is often distributed in both time and frequency domains. The disclosed embodiments employ comprehensive joint information processing in both domains.

Second, the insights are usually low-dimensional. Indeed most are one-dimensional metrics. The disclosed embodiments employ information compression procedures, while also maximizing the preserved information.

Third, while the physical layer insights need not be obtained in real-time, they should be obtained at least in near real-time. The disclosed embodiments may be executed in near real-time while maintaining optimal performance quality (i.e., to estimate the desired metric with a minimal amount of error, subject to timing, processing, power, and other constraints).

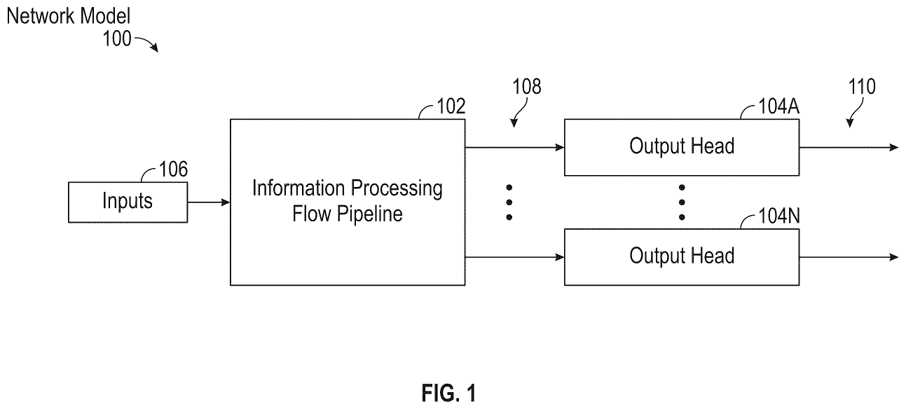

The disclosed embodiments may employ a network model that includes two stages: a processing flow pipeline and multiple output heads. FIG. 1 illustrates a network model 100 according to some embodiments of the disclosed technology. Referring to FIG. 1, the first stage includes an information processing flow pipeline 102 and the second stage includes N output heads 104A-104N. The information processing flow pipeline 102 may process an input 106 to extract and compress the meaningful information contained therein. This information 108 may then processed by the output heads 104A-104N to produce the desired network insights 110. The inputs 106 may include a channel estimate. The inputs 106 may include other parameters available to the network. In some embodiments, the dimensions of the inputs 106 may be 3276×2 per channel estimation period (based on a channel with 3276 subcarriers: 3276 with complex, i.e., real and imaginary components: 2).

Each output head 104A-104N may be implemented as a machine learning model, and may be trained according to the desired physical layer insight(s). In some embodiments, each head is a Dense Neural Network (DNN). Each DNN may map the input information 108 to the proper tangible output insights 110.

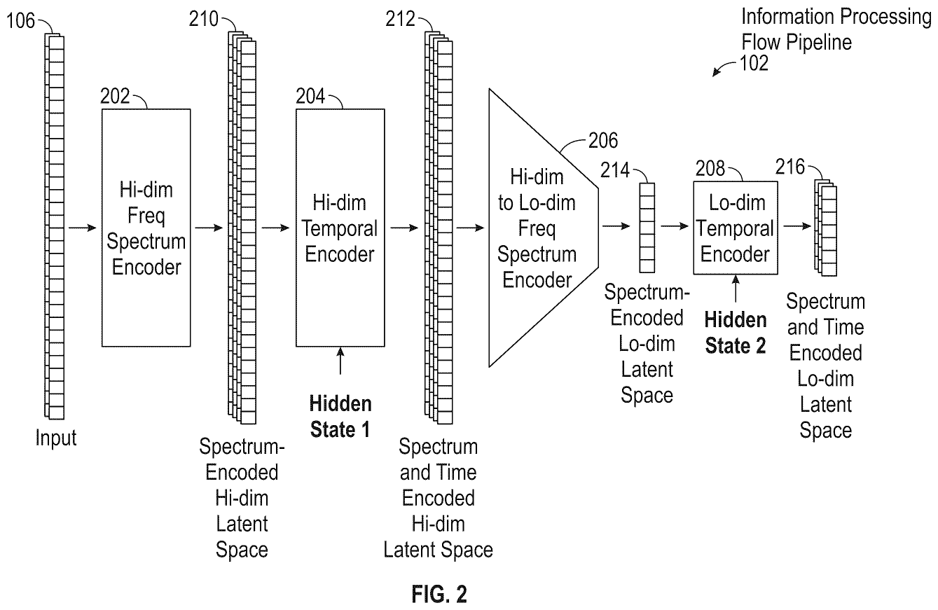

The information processing flow pipeline 102 may employ a two-stage deep-learning process. FIG. 2 illustrates an information processing flow pipeline 102 according to some embodiments of the disclosed technology. Referring to FIG. 2, the information processing flow pipeline 102 may include a high-dimensional frequency spectrum encoder 202, a high-dimensional temporal encoder 204, a high-to-low-dimensional frequency spectrum encoder 206, and a low-dimensional temporal encoder 208. The high-dimensional temporal encoder 204 and the low-dimensional temporal encoder 208 may be hidden states of a recurrent neural network model.

The high-dimensional frequency spectrum encoder 202 may receive the inputs 106, which may be generated every five time slots in an OFDM-based system. In such systems, a channel estimate represents the radio conditions across multiple subcarriers at a given moment, where each subcarrier is a narrow frequency band that carries part of the overall data. The high-dimensional frequency spectrum encoder 202 may include a convolutional neural network (CNN) layer. The CNN layer may process the subcarriers of a single slot and identify correlations or dependencies among them in the frequency domain. By capturing how different subcarriers interact—such as tracking phase and amplitude relationships—the encoder effectively increases the number of representational “channels” it produces. This process generates a richer, higher-dimensional latent space that encapsulates detailed frequency-domain information. The output of the encoder 202 may be a spectrum-encoded high-dimensional latent space 210. In some embodiments, the dimensions of the latent space 210 may be 3276×5×N (based on 5 channels with each channel having 3276 subcarriers with a time-series memory of length N, where N represents the length of the time-series memory that helps the model retain temporal context).

The high-dimensional temporal encoder 204 may receive the spectrum-encoded high-dimensional latent space 210, which already captures the complex frequency-domain relationships from the previous encoder stage. The high-dimensional temporal encoder 204 may include a 2-layer gated recurrent unit (GRU) to process the data over multiple time slots, enabling the model to learn and retain essential temporal correlations. The GRU may understand and encode all the meaningful temporal dependencies/correlations, and therefore further expands the size of the output. The output of the encoder 204 may be a spectrum- and time-encoded high-dimensional latent space 212. In some embodiments, the dimensions of the latent space 212 may be 3276×20×N (based on 20 being the hidden state size for each subcarrier slot and 3276 subcarriers with a time-series memory of length N). In some embodiments, the GRU's internal feedback structure and parameters implicitly retain a time-series length memory of N channel estimation periods, ensuring that relevant information from previous channel estimation periods influences the final encoding.

The high-to-low-dimensional frequency spectrum encoder 206 may receive the spectrum- and time-encoded high-dimensional latent space 212, which has already been enriched with both spectral and temporal information by the previous encoders. The high-to-low-dimensional frequency spectrum encoder 206 may include a three-layer CNN. The three-layer CNN may extract and compress the spatial information expanded by encoders 202 and 204. In practice, the three-layer CNN may identify and preserve important frequency-domain patterns while discarding redundant information, thereby reducing the dimensionality of the data while preserving as much relevant information as possible. For example, the three-layer CNN may reduce the dimensionality of the data from 3276×20×N to 10×N. The output of the encoder 206 may be a spectrum-encoded low-dimensional latent space 214. In some embodiments, the dimensions of the latent space 214 may be (frequency-domain reduced length: 19, Channels: 7) after first-stage compression and 10 after second-stage compression.

The low-dimensional temporal encoder 208 may receive the spectrum-encoded low-dimensional latent space 214. The low-dimensional temporal encoder 208 may include a GRU. The GRU may track the spectrum-encoded low-dimensional latent space 216, further encoding the latent space 216 while maintaining as much information as possible. The output of the encoder 208 may be a spectrum- and time-encoded latent space, which may be received by the output heads 104 as the information 108. In some embodiments, the dimension of the information 108 may be 1 for each output head 104. In some embodiments, the GRU's internal feedback structure and parameters implicitly retain a time-series length memory of N channel estimation periods.

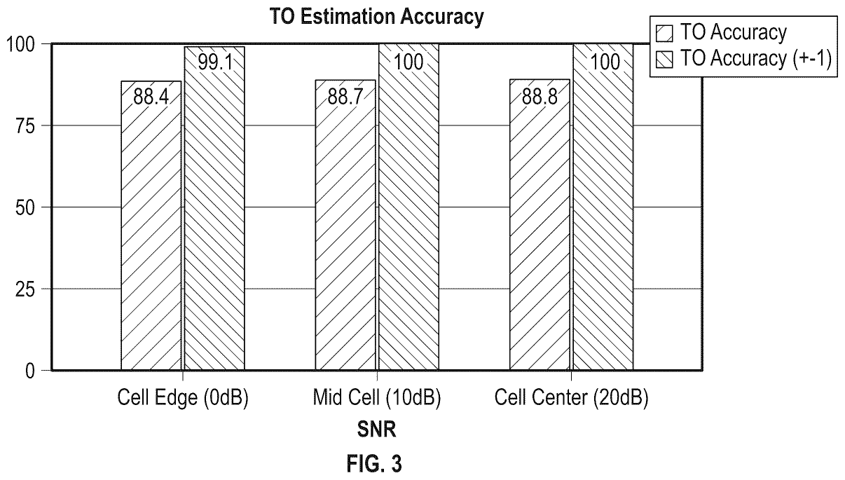

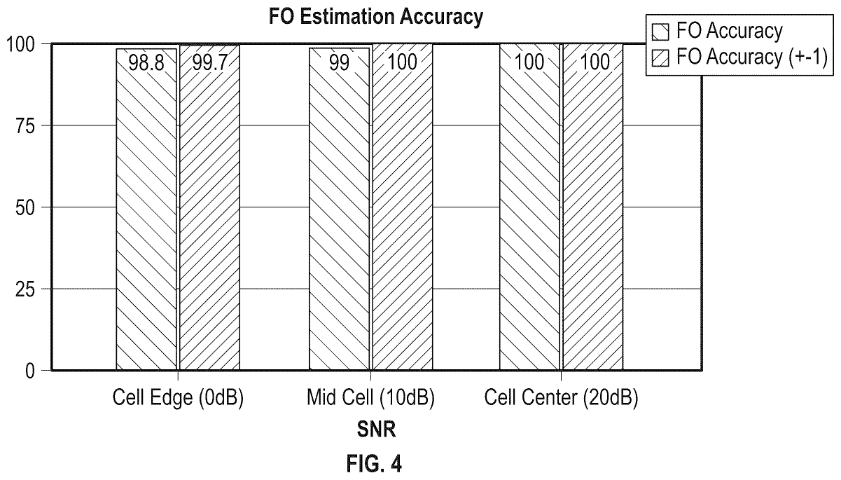

The disclosed network model has been numerically tested to estimate and compensate for frequency offset and timing offset over a static channel. The channel instances were simulated in MATLAB with an added random frequency offset in the range of 0-60 Hertz and a delay spread in the range of 20-70 samples. The test results are presented in FIGS. 3 and 4. In these bar plots, the offset estimation accuracy results are shown for three SNR values at a 5G cell center (20 dB), mid cell (10 dB), and cell edge (0 dB). The bar plots show both the absolute accuracy (“Accuracy”, i.e. the estimated value output from the neural net exactly matches the true value) and the accuracy within 1 unit of the true value (“Accuracy+−1”, i.e. the estimated value output from the neural net is either an exact match with the true value or it's no more than 1 unit off).

FIG. 3 is a bar plot of the timing offset (TO) estimation accuracy results at various locations within a cell. As can be seen in FIG. 3, the accuracy of the results ranges from 88.4 to 88.8 percent when the output neural network head unit must exactly estimate the true value, and from 99.1 to 100 percent when the output neural network head unit must be within one unit of the true value.

FIG. 4 is a bar plot of the frequency offset (FO) estimation accuracy results. As can be seen in FIG. 4, the accuracy of the results range from 98.8 to 100 percent when the output neural network head must exactly estimate the true value, and from 99.7 to 100 percent when the output neural network head must be within one unit of the true value.

The disclosed network model also has been numerically tested to gauge the performance of the SNR estimation, delay spread estimation, and Doppler estimation. The channel estimates are compensated for timing offset and frequency offset, so the input to the network model for SNR estimation, delay spread estimation, and Doppler estimation is based on compensated timing offset and frequency offset.

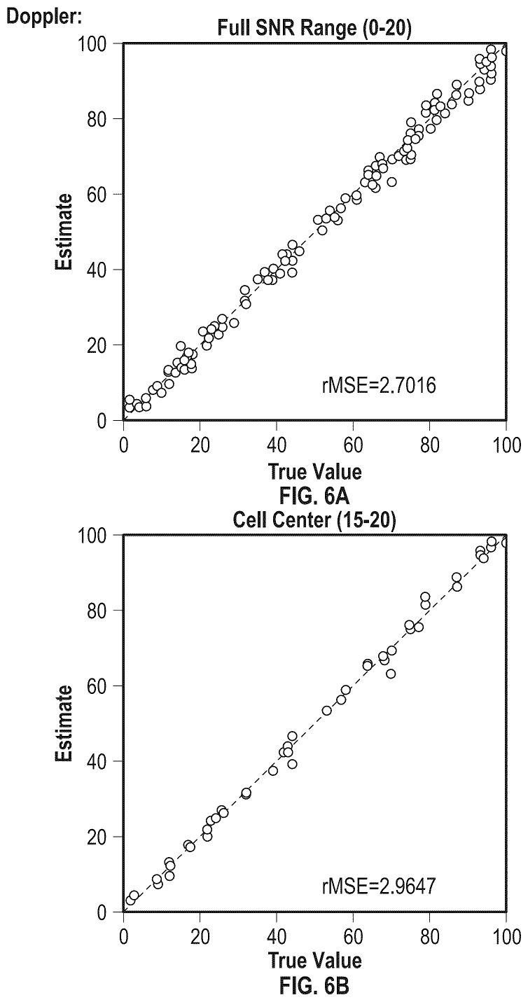

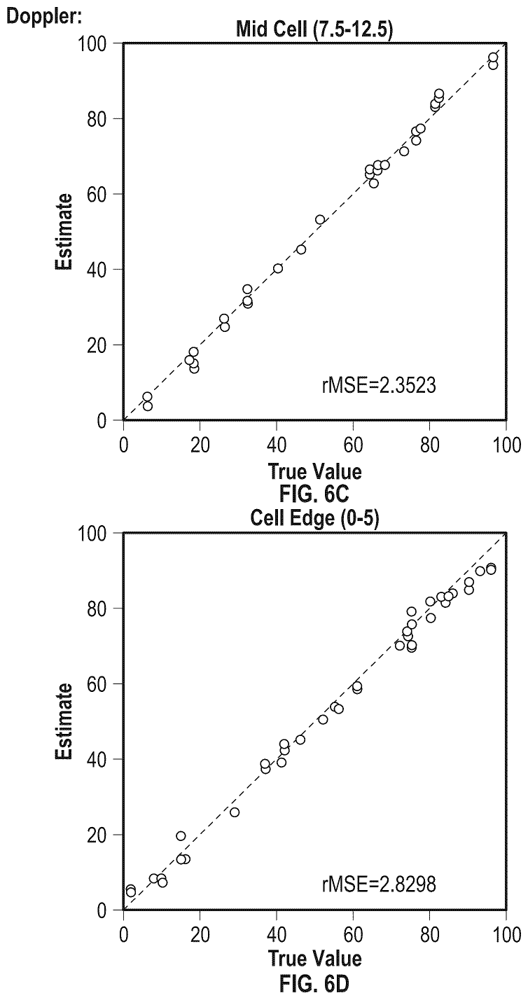

The network model was trained and tested for three SNR values at a 5G cell center (15-20 dB), mid cell (7.5-12.5 dB), and cell edge (0-5 dB). However, other values may be used to define these regions. For both training and testing, the input signal's parameters were varied, the SNR was uniformly randomly selected from the range of 0 to 20 dB, the Doppler was uniformly randomly selected from the range of 0 to 100 Hz, and the delay spread was uniformly randomly selected from the range of 0 to 300 nanoseconds. FIGS. 6, 7, and 8 are scatter plots of the test results. The scatter plots show the results of the network model and head end unit's estimated values vs. the true underlying value using root mean square error (rMSE) as a measure of the average difference between the head end unit's statistical prediction against the true value.

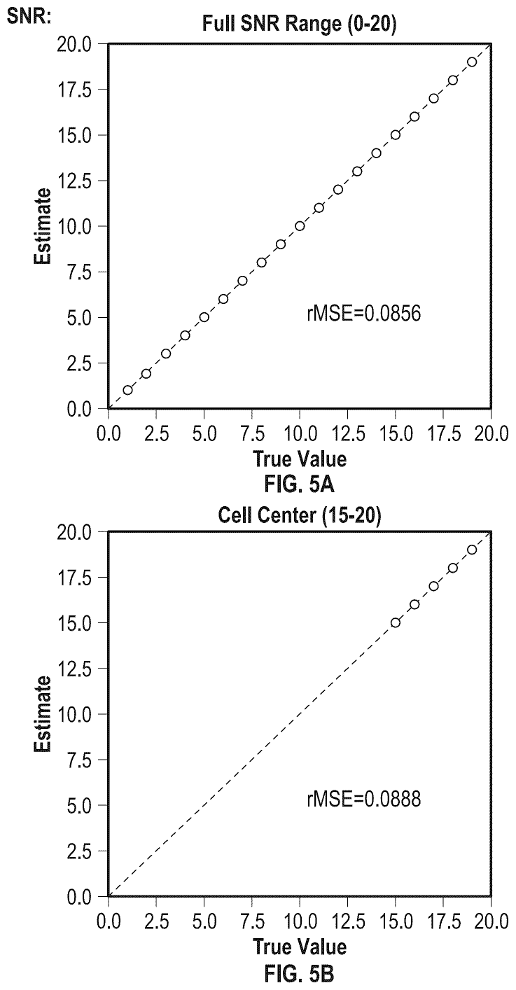

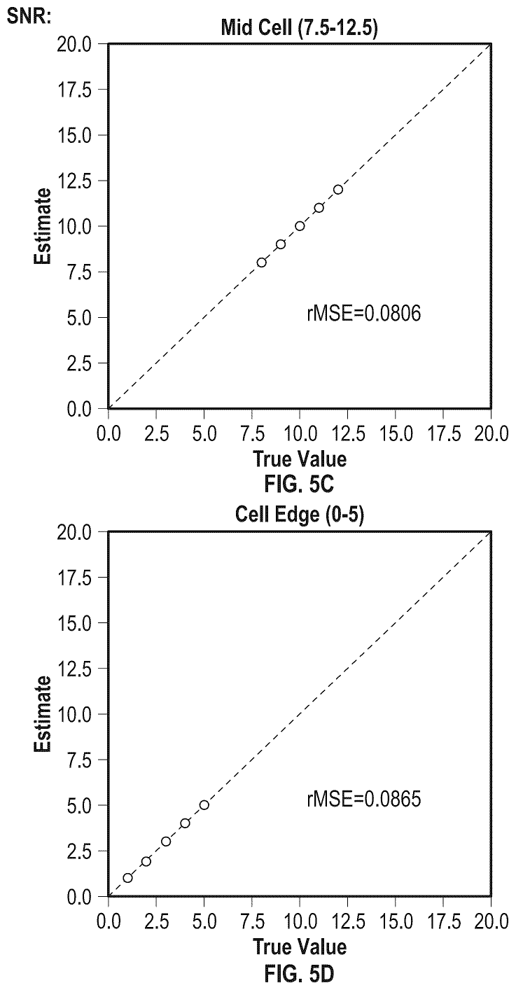

FIGS. 5A-5D are scatter plots of the performance of the system with respect to SNR estimation at various locations within a cell. As can be seen in FIGS. 5A-5D, the rMSE results range from 0.0865 at the cell edge to 0.0888 at the cell center with a rMSE of 0.0856 over the range of 0 to 20 dB.

FIGS. 6A-6D are scatter plots of the performance of the system with respect to Doppler estimation at various locations within a cell. As can be seen in FIGS. 6A-6D, the rMSE results range from 2.8298 at cell edge to 2.9647 at cell center with a rMSE of 2.7016 over the full SNR range of 0 to 20 dB.

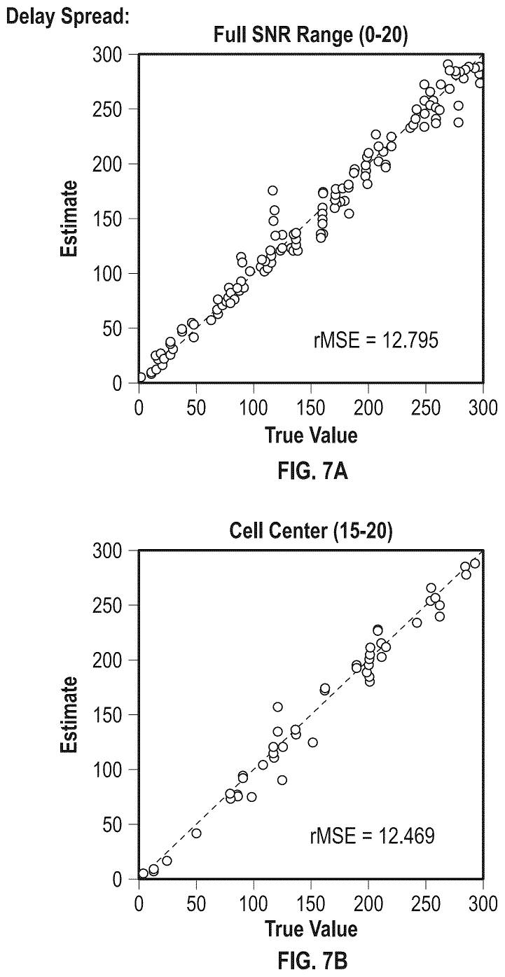

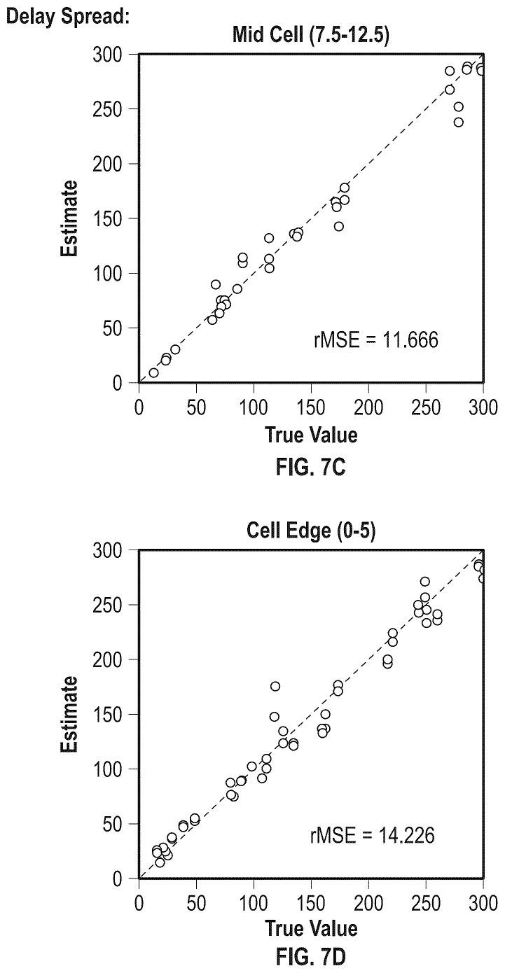

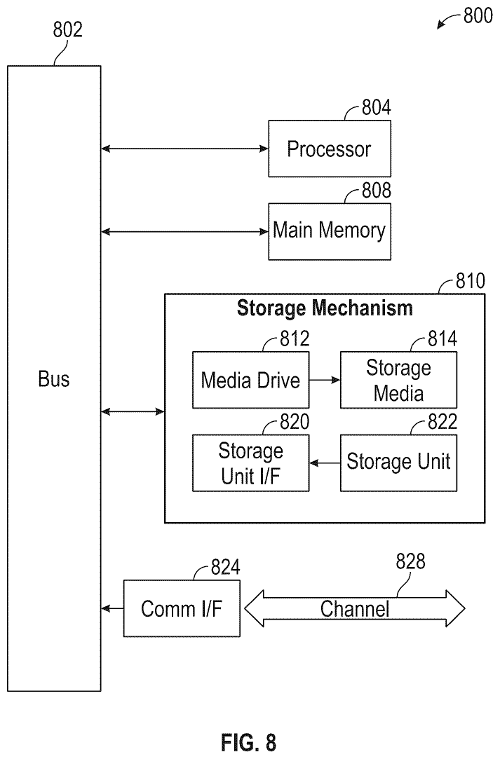

FIGS. 7A-7D are scatter plots of the performance of the system with respect to delay spread estimation at various locations within a cell. As can be seen in FIGS. 7A-7D, the rMSE results range from 14.226 at cell edge to 12.469 at cell center with a rMSE of 12.795 over the full SNR range of 0 to 20 dB.

Where components or modules of the application are implemented in whole or in part using software, in one embodiment, these software elements can be implemented to operate with a computing or processing module capable of carrying out the functionality described with respect thereto. One such example computing module is shown in FIG. 8. Various embodiments are described in terms of this example-computing module 800. After reading this description, it will become apparent to a person skilled in the relevant art how to implement the application using other computing modules or architectures.

Referring now to FIG. 8, computing module 800 may represent, for example, computing or processing capabilities found within desktop, laptop, notebook, tablet, cloud and edge, computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally. The bus 802 may also be connected to other components such as a display, input devices, or cursor control to help facilitate interaction and communications between the processor and/or other components of the computing module 800.

Computing module 800 might also include one or more memory modules, simply referred to herein as main memory 808. For example, preferably random-access memory (RAM) or other dynamic memory might be used for storing information and instructions to be executed by processor 804. Main memory 808 might also be used for storing temporary variables or other intermediate information during execution of instructions to be executed by processor 804. Computing module 800 might likewise include a read only memory (“ROM”) or other static storage device 810 coupled to bus 802 for storing static information and instructions for processor 804.

Computing module 800 might also include one or more various forms of information storage devices 810, which might include, for example, a media drive 812 and a storage unit interface 820. The media drive 812 might include a drive or other mechanism to support fixed or removable storage media 814. For example, a hard disk drive, a floppy disk drive, a magnetic tape drive, an optical disk drive, a CD, DVD or Bluray drive (R or RW), or other removable or fixed media drive 812 might be provided. Accordingly, storage media 814 might include, for example, a hard disk, a floppy disk, magnetic tape, cartridge, optical disk, a CD or DVD, or other fixed or removable medium that is read by, written to or accessed by media drive 812. As these examples illustrate, the storage media 814 can include a computer usable storage medium having stored therein computer software or data.

In alternative embodiments, information storage devices 810 might include other similar instrumentalities for allowing computer programs or other instructions or data to be loaded into computing module 800. Such instrumentalities might include, for example, a fixed or removable storage unit 822 and a storage unit interface 820. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 800.

Computing module 800 might also include a communications interface or network interface(s). Communications or network interface(s) interface might be used to allow software and data to be transferred between computing module 800 and external devices. Examples of communications interface or network interface(s) might include a modem or soft modem, a network interface (such as an Ethernet, network interface card, WiMedia, WiFi, IEEE 802.XX or other interface), a communications port (such as, for example, a USB port, IR port, RS232 port Bluetooth® interface, or other port), or other communications interfaces. Software and data transferred via communications or network interface(s) might typically be carried on signals, which can be electronic, electromagnetic (which includes optical) or other signals capable of being exchanged by a given communications interface. These signals might be provided to communications interface via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 808, ROM, and storage unit interface 820. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and FIGS. are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system, comprising:
one or more hardware processors; and
one or more non-transitory machine-readable storage media encoded with instructions that, when executed by the one or more hardware processors, cause the system to perform operations comprising:
receiving input data comprising a channel estimate for a channel of a wireless network;
encoding, using a high-dimensional frequency spectrum encoder, frequency-domain dependencies and correlations among a plurality of subcarriers of the channel based on the input data to generate a spectrum-encoded high-dimensional latent space;
encoding, using a high-dimensional temporal encoder, temporal dependencies across multiple time slots based on the spectrum-encoded high-dimensional latent space to generate a spectrum- and time-encoded high-dimensional latent space;
compressing, using a high-to-low-dimensional frequency spectrum encoder, the spectrum- and time-encoded high-dimensional latent space to generate a spectrum-encoded low-dimensional latent space;
encoding, using a low-dimensional temporal encoder, the spectrum-encoded low-dimensional latent space to capture temporal dependencies, thereby generating spectrum- and time-encoded latent space; and
generating at least one operational indicator of a physical layer of the wireless network by applying the spectrum- and time-encoded latent space to at least one output head.

2. The system of claim 1, wherein the high-dimensional frequency spectrum encoder comprises:
a convolutional neural network (CNN) layer.

3. The system of claim 1, wherein the high-dimensional temporal encoder comprises:
a 2-layer gated recurrent unit (GRU).

4. The system of claim 1, wherein the high-to-low-dimensional frequency spectrum encoder comprises:
a three-layer CNN.

5. The system of claim 1, wherein the low-dimensional temporal encoder comprises:
a GRU.

6. The system of claim 1, wherein the at least one output head comprises:
a Dense Neural Network (DNN).

7. The system of claim 1, wherein the wireless network comprises an Orthogonal Frequency Division Multiplexing (OFDM) communication system.

8. The system of claim 1, wherein the generating at least one operational indicator of the physical layer comprises:
generating physical layer insights of the wireless network using a plurality of output heads, each implemented as a trained machine learning model, wherein each output head receives the spectrum- and time-encoded latent space and generates at least one physical layer metric indicative of network conditions.

9. The system of claim 8, wherein the plurality of output heads comprise dense neural networks, each trained to output a respective one-dimensional metric relating to physical layer parameters of the wireless network, including at least one of frequency offset and timing offset.

10. The system of claim 3, wherein the spectrum- and time-encoded high-dimensional latent space has dimensions determined by a hidden state size of the GRU and a selected time-series memory length.

11. A method of generating physical layer insights in an Orthogonal Frequency Division Multiplexing (OFDM) communication system, the method comprising:
receiving input data comprising a channel estimate for a channel of a wireless network;
encoding, using a high-dimensional frequency spectrum encoder, frequency-domain dependencies and correlations among a plurality of subcarriers of the channel based on the input data to generate a spectrum-encoded high-dimensional latent space;
encoding, using a high-dimensional temporal encoder, temporal dependencies across multiple time slots based on the spectrum-encoded high-dimensional latent space to generate a spectrum- and time-encoded high-dimensional latent space;
compressing, using a high-to-low-dimensional frequency spectrum encoder, the spectrum- and time-encoded high-dimensional latent space to generate a spectrum-encoded low-dimensional latent space;
encoding, using a low-dimensional temporal encoder, the spectrum-encoded low-dimensional latent space to capture temporal dependencies, thereby generating spectrum- and time-encoded latent space; and
generating at least one operational indicator of a physical layer of the wireless network by applying the spectrum- and time-encoded latent space to at least one output head.

12. The method of claim 11, wherein the generating at least one operational indicator of the physical layer comprises:
generating physical layer insights of the wireless network using a plurality of output heads, each implemented as a trained machine learning model, wherein each output head receives the spectrum- and time-encoded latent space and generates at least one physical layer metric indicative of network conditions.

13. The method of claim 12, wherein the plurality of output heads comprise dense neural networks, each trained to output a respective one-dimensional metric relating to physical layer parameters of the wireless network, including at least one of frequency offset and timing offset.

14. The method of claim 11, wherein high-dimensional temporal encoder comprises a 2-layer gated recurrent unit (GRU).

15. The method of claim 14, wherein the spectrum- and time-encoded high-dimensional latent space has dimensions determined by a hidden state size of the GRU and a selected time-series memory length.

16. Non-transitory computer-readable storage media storing instructions that, when executed by one or more processors, cause the one or more processors to perform operations comprising:
receiving input data comprising a channel estimate for a channel of a wireless network;
encoding, using a high-dimensional frequency spectrum encoder, frequency-domain dependencies and correlations among a plurality of subcarriers of the channel based on the input data to generate a spectrum-encoded high-dimensional latent space;
encoding, using a high-dimensional temporal encoder, temporal dependencies across multiple time slots based on the spectrum-encoded high-dimensional latent space to generate a spectrum- and time-encoded high-dimensional latent space;
compressing, using a high-to-low-dimensional frequency spectrum encoder, the spectrum- and time-encoded high-dimensional latent space to generate a spectrum-encoded low-dimensional latent space;
encoding, using a low-dimensional temporal encoder, the spectrum-encoded low-dimensional latent space to capture temporal dependencies, thereby generating spectrum- and time-encoded latent space; and
generating at least one operational indicator of a physical layer of the wireless network by applying the spectrum- and time-encoded latent space to at least one output head.

17. The non-transitory computer-readable storage media of claim 16, wherein the generating at least one operational indicator of the physical layer comprises:
generating physical layer insights of the wireless network using a plurality of output heads, each implemented as a trained machine learning model, wherein each output head receives the spectrum- and time-encoded latent space and generates at least one physical layer metric indicative of network conditions.

18. The non-transitory computer-readable storage media of claim 17, wherein the plurality of output heads comprise dense neural networks, each trained to output a respective one-dimensional metric relating to physical layer parameters of the wireless network, including at least one of frequency offset and timing offset.

19. The non-transitory computer-readable storage media of claim 16, wherein high-dimensional temporal encoder comprises a 2-layer gated recurrent unit (GRU).

20. The non-transitory computer-readable storage media of claim 19, wherein the spectrum- and time-encoded high-dimensional latent space has dimensions determined by a hidden state size of the GRU and a selected time-series memory length.
